(19) United States
(12) Patent Application Publication
(10) Pub. No.: US 2021/0004743 A1
(43) Pub. Date: Jan. 7, 2021

(54) METHODS AND SYSTEMS FOR FACILITATING EXPLORATION OF DATA TO EVALUATE ACTIVITIES AND BEHAVIORAL PATTERNS FOR MAKING DECISIONS

(71) Applicant: Gustavo Zarrate-Cardenas, Tampa, FL (US)

(72) Inventor: Gustavo Zarrate-Cardenas, Tampa, FL (US)

(21) Appl. No.: 16/920,282

(22) Filed: Jul. 2, 2020

Related U.S. Application Data
(60) Provisional application No. 62/870,431, filed on Jul. 3, 2019.

(51) Int. Cl. G06Q 10/06; G06F 16/29; G06N 5/04; G06F 16/25; G06F 3/0481

(52) U.S. Cl. CPC G06Q 10/06312; G06F 16/29; G06F 3/04817; G06F 16/258; G06N 5/04

(57) ABSTRACT

Disclosed herein is a method for facilitating exploration of data to evaluate activities and behavioral patterns for making decisions. Further, the method may include receiving a request from a device of multiple devices, generating a smart locator, transmitting the smart locator to the device, receiving at least one search information from the device based on the transmitting of the smart locator, transmitting at least one search result to the device based on the receiving of the at least one search information, receiving at least one analysis choice from the device based on the transmitting of the at least one search result, conducting at least one analysis corresponding to the at least one analysis choice on the at least one search result, generating at least one analysis result based on the conducting of the at least one analysis and transmitting the at least one analysis result to the device.

The current application claims a priority to the U.S. Provisional Patent application Ser. No. 62/870,431 filed on Jul. 3, 2019.

### FIELD OF THE INVENTION

Generally, the present disclosure relates to the fields of data processing, analytics, and geographic information analysis. More specifically, the present disclosure relates to methods and systems for facilitating exploration of data to evaluate activities and behavioral patterns for making decisions.

### BACKGROUND OF THE INVENTION

A geographic information system (GIS) is normally used by users, industry, local and federal government entities for a wide range of applications including demographic analyses, decision-making, development planning, budgeting, etc. Most existing GIS data systems generally utilize a variety of data types, including, imagery, maps, and location-based information, such as schools, retail stores, restaurants, hospitals, and so on. These systems typically enable a user to locate desired information and data by specifying a geographic region of interest. For example, a GIS system may allow a user to identify real estate listings in a desired geographic area. In some systems, the user is allowed to interact with a map to locate and analyze data and social behaviors of interest. However, many conventional GIS systems have limited usefulness in both their overall functionality and user interface by requiring a user to disambiguate the nature of a search request, selecting search scopes like “address search” or “lot number search” as either an explicit component of the search process or implicitly by allowing only a single scope such as an address within which all search requests are interpreted.

Most existing GIS and Analytics systems lack the capability to provide geographical data/information based on specific search criteria relevant to the particular businesses or government organization, and their business plans or community projects. Further, the GIS and Analytics system is not able to offer data related to regional economic growth rates, tax rates, and available state and local incentives with location demographics, such as cost of living factors, and local income and education levels. Additionally, existing GIS and Analytics systems do not enable a user to conduct comparisons using data associated with one prospective region to data associated with another prospective region. Further, most existing GIS and Analytics platforms are not able to run simulations, such as what-if scenarios, hypothesis tests, strategic planning, and resource allocation and assignments tests using the data or information.

Therefore, there is a need for improved methods and systems for facilitating exploration of data to evaluate activities and behavioral patterns for making decisions that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter, nor is this summary intended to be used to limit the claimed subject matter's scope.

Disclosed herein is a method for facilitating exploration of data to evaluate activities and behavioral patterns for making decisions. Furthermore, the method may include receiving or using a communication device, a request from a device of a plurality of devices, and the request may include at least one identifier of the device. Additionally, the method may include generating, using a processing device, a smart locator, which may include at least one searchable map based on the receiving of the request. Further, the method may include transmitting, using the communication device, the smart locator to the device. Further, the method may include receiving, using the communication device, at least one piece of search information from the device based on the transmitting of the smart locator. Further, the method may include transmitting, using the communication device, at least one search result to the device based on the receiving of the at least one search information. Further, the at least one search result may include geographical data. Further, the method may include receiving, using the communication device, at least one analysis choice from the device based on the transmitting of the at least one search result. Further, the method may include conducting, using the processing device, at least one analysis corresponding to the at least one analysis choice on the at least one search result. Further, the method may include generating, using the processing device, at least one analysis result based on the conduction of at least one analysis. Further, the method may include transmitting, using the communication device, the at least one analysis result to the device.

Further, disclosed herein is a system for facilitating exploration of data to evaluate activities and behavioral patterns for making decisions. Further, the system may include a communication device and a processing device. Further, the communication device may be configured for receiving a request from a device of a plurality of devices. Further, the communication device may be configured for transmitting a smart locator to the device. Further, the communication device may be configured for receiving at least one piece of search information from the device based on the transmitting of the smart locator. Further, the communication device may be configured for transmitting at least one search result to the device based on the receiving of the at least one search information. Further, the at least one search result may include geographical data. Further, the communication device may be configured for receiving at least one analysis choice from the device based on the transmitting of the at least one search result. The communication device may be configured for transmitting at least one analysis result to the device. Further, the processing device configured for generating the smart locator. Further, the processing device configured for conducting at least one analysis corresponding to the at least one analysis choice on the at least one search result. Further, the processing device may be configured for generating at least one analysis result based on the conducting of the at least one analysis.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating exploration of data to evaluate activities and behavioral patterns for making decisions, in accordance with some embodiments.

FIG. 3 is a block diagram of a system for facilitating exploration of data to evaluate activities and behavioral patterns for making decisions, in accordance with further embodiments.

FIG. 4 is a flowchart of a method for facilitating exploration of data to evaluate activities and behavioral patterns for making decisions, in accordance with some embodiments.

FIG. 5 is a flowchart of a method for sending a report to the device, in accordance with some embodiments.

FIG. 6 is a flowchart of a method for sending at least one residential development tracking result to the device, in accordance with some embodiments.

FIG. 7 is a flowchart of a method for sending student enrollment analysis data to the device, in accordance with some embodiments.

FIG. 8 is a flowchart of a method for performing at least one resource assignment analysis, in accordance with some embodiments.

FIG. 9 is a flowchart of a method for performing at least one of a search and an analysis for at least one exceptional community member, in accordance with some embodiments.

FIG. 10 is a flowchart of a method for at least one possible outcome scenario to the device, in accordance with some embodiments.

FIG. 11 is a flowchart of a method for saving data, in accordance with some embodiments.

FIG. 12 is a block diagram of a system to manage a geographical and analytical suite of processes for a plurality of users, in accordance with some embodiments.

FIG. 13 is a flow chart of a method to manage a geographical and analytical suite of processes for a plurality of users, in accordance with some embodiments.

FIG. 14 is a flowchart of a method for managing residential development tracking for a desired geographical location for the specific user, in accordance with some embodiments.

FIG. 15 is a flowchart of a method for managing student enrollment analysis for a specific user, in accordance with some embodiments.

FIG. 16 is a flowchart of a method for managing resource assignment analysis for a specific user, in accordance with some embodiments.

FIG. 17 is a flowchart of a method the method for managing exceptional community member analysis for a specific user, in accordance with some embodiments.

FIG. 18 is a flowchart of a method for managing what-if scenario analysis for a specific user, in accordance with some embodiments.

FIG. 19 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issuing here from which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one,” but do not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating exploration of data to evaluate activities and behavioral patterns for making decisions, embodiments of the present disclosure are not limited to use only in this context.

In general, the method disclosed herein may be performed by one or more computing devices. For example, in some embodiments, the method may be performed by a server computer in communication with one or more client devices over a communication network such as, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, but not limited to, analyzing, identifying, determining, generating, transforming, calculating, computing, compressing, decompressing, encrypting, decrypting, scrambling, splitting, merging, interpolating, extrapolating, redacting, anonymizing, encoding, and decoding. Further, the server computer may include a communication device configured for communicating with one or more external devices. The one or more external devices may include, for example, but are not limited to, a client device, a third-party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the methods disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the methods may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, a GLONASS-K2 receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the methods may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performances of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data between corresponding to one or more steps of the method. For example, in a client-server or cloud-based environment, sensitive data corresponding to a user may not be allowed to be transmitted to the server computer. Accordingly, one or more steps of the method operating on the sensitive data and/or a derivative thereof may be performed at the client device.

Overview:

The present disclosure relates generally to the fields of data processing, analytics, and geographic information analysis. More specifically, the present disclosure relates to a method and system that provides a user with online visual exploration of geographical and analytical data to evaluate social activities and behavioral patterns for making transparent, efficient, and strategic decisions. The method and system of the present disclosure integrates heterogeneous data sources to facilitate multidisciplinary data mashup and offers efficient tracking of residential and community developments, what-if scenario analyses to support assessment of various options for solving a geographical problem. Additionally, the method provides an effective data management and an integrated modular workflow to the user for school planning, growth management, and facility service management, allowing the user to focus on insight finding and hypothesis testing. Further, the present disclosure facilitates visual data exploration using thematic filters to achieve fast responses and on-the-fly solutions to strategic decision-making, hypothesis, and scenarios.

Further, the present disclosure relates a system and method of geographical and analytical web services (GAWS) system to a user. The method and system of the present disclosure offers the user with a geographical and analytical suite of processes to explore and evaluate behavioral patterns of social activity, track community development, set up what-if scenarios and visualize spatially aggregated data through the online GAWS platform. More specifically, the present disclosure enables the user to conduct online visual exploration of geographical and analytical data to evaluate social activities, behavioral patterns, and community development for making transparent, efficient, and strategic decisions. Using an open bridge ETL (extract, transform, and load) data translator engine, the method and system of the present disclosure integrates heterogeneous data sources to facilitate multidisciplinary data mashup and enables the user to interactively browse through various portions of data and information available on the GAWS system. The method offers efficient tracking of residential and community developments, what-if scenario analyses, hypothesis testing, and strategic planning simulations to support assessment of various options for solving a geographical problem, such as school planning, growth management, and others. The GAWS of the present disclosure includes a smart locator which allows the user to efficiently conduct searches by address and clickable map elements. The student enrollment analyzer of the GAWS provides powerful data analysis for enrollment information of K-12 students in the schools of a desired school district. Not only does the GAWS enables the user to analyze any multi-data source and ad-hoc inquiries, but also visualize the search results instantly. Additionally, the method of the GAWS provides an effective data management and an integrated modular workflow to the user for facility service management and allows the user to focus on insight finding and hypothesis testing through a module called Scenario Builder, which can be used as an efficient community planning and school planning tool. Further, the present disclosure facilitates visual data exploration using thematic filters to achieve fast responses and on-the-fly solutions to strategic decision-making, hypothesis, and scenarios. The resource assignment analyzer of the GAWS allows community leaders to plan community resource repartition ensuring that all members, whether the most privileged or the most underprivileged, receive equal opportunity to the access to the limited community resources. Additionally, the exceptional community member analyzer of the GAWS enables the community leaders to effectively allocate community resources to serve special community members who are identified as either disabled or gifted. Further, GAWS utilizes a SABI (smart analyzer business intelligence) reporting module to provide the user with an effective and dynamic information delivery, which processes data in a timely fashion and generates proper reporting and analysis to drive proactive decision-making and comprehensive development action plans. Thus, the present disclosure can offer significant value and services to users to make transparent, efficient, and effective strategic decisions that stakeholders and community members expect from them as decision makers.

Further, the present disclosure provides a method and system, called GAWS (Geographical and Analytical Web Service), to a user with online visual exploration of geographical and analytical data to evaluate social activities, behavioral patterns, and community development for making transparent, efficient, and strategic decisions. The present disclosure comprises a suite (or set) of components working concurrently with one another in accordance with the customer needs, organizational requirements and particular specifications driven by installation parameters

Further, Community Services Inventory and Resource Assignment Analyzer allows community members, leaders and partners to plan, publish, and search for community resources, such as financial advising, child care, tax preparation, math tutoring, and the like, available through the participation of community government bodies and partners. This resource mapping and publishing platform foster for the rapid and effective delivery of information to potential participants through the use of geographical tools and analytical methods. Business and community partners, with the support of local government agencies, organize campaigns to improve the well-being of community members with the use of tools that facilitate the identification of beneficiary candidates to these community resources; a multivariable model combining location, demographics, census data, real estate market, and others, is available to rank potential areas of offer for the campaign; additionally, an approval mechanism is in place to allow partners and community leaders to agree about the campaign scope in terms of content, duration, delivery method, and others. Once a campaign is approved, its details both in service locations, requirements to apply to, duration, and others are published through a geographical platform and any other digital mechanism such as emails, blogs, and social media.

Further, the final goal of this Community Services Inventory, Resource Assignment Analyzer and Mapping is to plan community resource repartition campaigns ensuring that all members, whether the most privileged or the most underprivileged, receive an equal opportunity to access the limited community resources.

Further, the method may include one or more implementations. Further, the one or more implementation may include a big number of implementation parameters working in accordance to local information from Census, Local Government and Real Estate market.

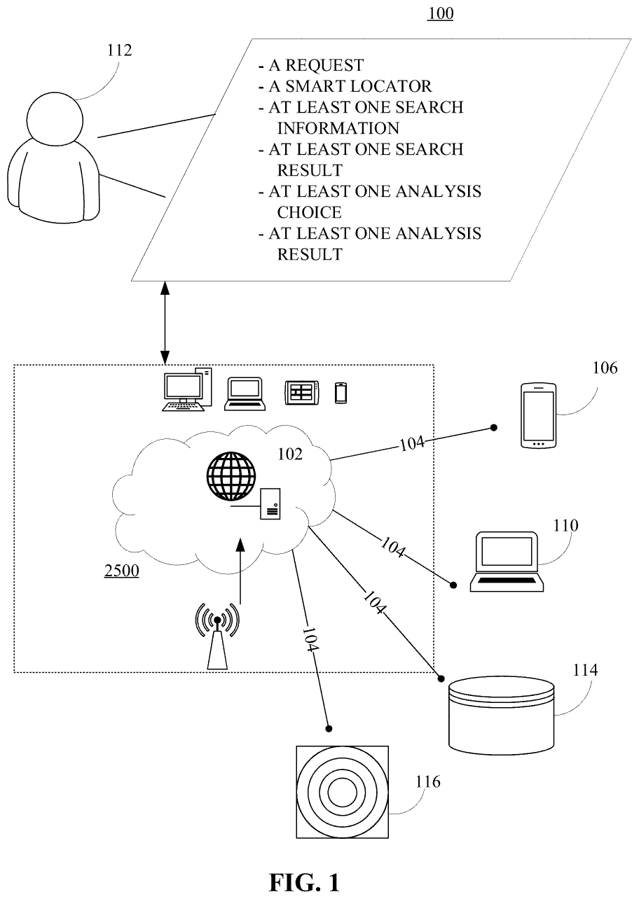

Referring now to figures, FIG. 1 is an illustration of an online platform 100 consistent with various embodiments of the present disclosure. By way of non-limiting example, the online platform 100 to facilitate exploration of data to evaluate activities and behavioral patterns for making decisions may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), and databases 114 over a communication network 104, such as, but not limited to, the Internet. Further, users of the online platform 100 may include relevant parties such as, but not limited to, end-users, users, administrators, and so on. Accordingly, in some instances, electronic devices operated by the one or more relevant parties may be in communication with the platform 100.

A user 112, such as the one or more relevant parties, may access online platform 100 through a web-based software application, browser or mobile-app. The web-based software application may be embodied as, for example, but not be limited to, a website, a web application, a desktop application, and a mobile application compatible with a computing device 2500.

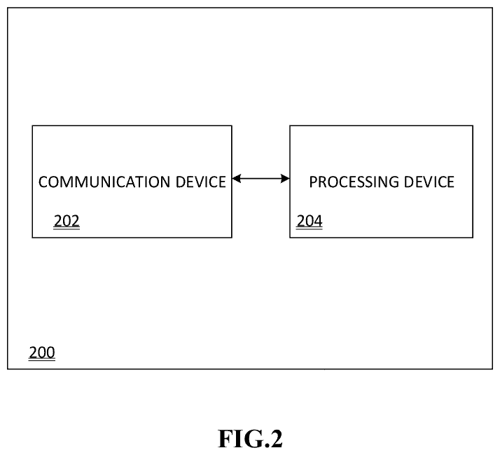

FIG. 2 is a block diagram of a system 200 for facilitating exploration of data to evaluate activities and behavioral patterns for making decisions, in accordance with some embodiments. Accordingly, the system 200 may include a communication device 202 and a processing device 204.

Further, the communication device 202 may be configured for receiving a request from a device of a plurality of devices. Further, the request may include at least one identifier of the device. Further, the plurality of devices may be associated with a plurality of users (such as the user 112). Further, the device may include a computing device such as, but not limited to, a smartphone, a laptop, a desktop, a PC device, a smartwatch, a tablet, and so on.

Further, the communication device 202 may be configured for transmitting a smart locator to the device.

Further, the communication device 202 may be configured for receiving at least one search information from the device based on the transmitting of the smart locator. Further, the at least one search information may include at least one location address on at least one searchable map.

In some embodiments, the at least one searchable map may include at least one clickable location icon. Further, each clickable location icon of the at least one clickable location icon may be linked to data. Further, the at least one search information may include at least one selection of the at least one clickable location icon. Further, the data may include the geographical data.

In some embodiments, the at least one search information may be associated with a residential development tracking. Further, the processing device 204 may be configured for conducting at least one search on the at least one search result for tracking at least one residential development through a residential development tracking module. Further, the processing device 204 may be configured for generating at least one residential development tracking result based on the conducting of the at least one search on the at least one search result for tracking the at least one residential development. Further, the communication device 202 may be further configured for transmitting the at least one residential development tracking result to the device.

Further, the communication device 202 may be configured for transmitting at least one search result to the device based on the receiving of the at least one search information. Further, the at least one search result may include geographical data.

Further, the communication device 202 may be configured for receiving at least one analysis choice from the device based on the transmitting of the at least one search result.

Further, the communication device 202 may be configured for transmitting at least one analysis result to the device.

Further, the processing device 204 configured for generating the smart locator. Further, the smart locator may include the at least one searchable map based on the receiving of the request.

Further, the processing device 204 configured for conducting at least one analysis corresponding to the at least one analysis choice on the at least one search result.

Further, the processing device 204 configured for generating the at least one analysis result based on the conducting of the at least one analysis.

In further embodiments, the processing device 204 may be configured for obtaining the geographical data through a specialized data translator engine. Further, the specialized data translator engine may be configured for receiving, collecting, transforming, and loading the data from a plurality of sources to at least one database. Further, the plurality of sources may be non-homogeneous.

In further embodiments, the processing device 204 may be further configured for creating a report through a smart analyzer business intelligence (SABI) reporting module based on the generating of the at least one analysis result. Further, the communication device 202 may be further configured for transmitting the report to the device.

In further embodiments, the communication device 202 may be configured for receiving a plurality of datasets and at least one grouping choice from the device. Further, the communication device 202 may be configured for transmitting student enrollment analysis data to the device. Further, the processing device 204 may be configured for conducting at least one student enrollment analysis through a student enrollment analyzer module based on the receiving of the plurality of datasets and the at least one grouping choice. Further, the processing device 204 may be configured for generating the student enrollment analysis data.

In further embodiments, the communication device 202 may be configured for receiving at least one analysis specific information from the device. Further, the processing device 204 may be configured for conducting at least one resource assignment analysis through a resource assignment analyzer module based on the receiving of the at least one analysis specific information. Further, the generating of the student enrollment analysis data may be based on the conducting of the at least one resource assignment analysis.

In further embodiments, the communication device 202 may be configured for receiving at least one community information from the device. Further, the processing device 204 may be configured for conducting at least one of a search and an analysis for at least one exceptional community member through an exceptional member analyzer module based on the receiving of the at least one community information. Further, the generating of the student enrollment analysis data may be based on the conducting of at least one of the search and the analysis for the at least one exceptional community member.

In further embodiments, the communication device 202 may be configured for receiving at least one specific what-if scenario question from the device. Further, the communication device 202 may be configured for transmitting at least one possible outcome scenario to the device. Further, the processing device 204 may be configured for conducting at least one of a search and an analysis through a scenario builder module based on the receiving of the at least one specific what-if scenario question. Further, the processing device 204 may be configured for generating the at least one possible outcome scenario based on the conducting of at least one of the search and the analysis.

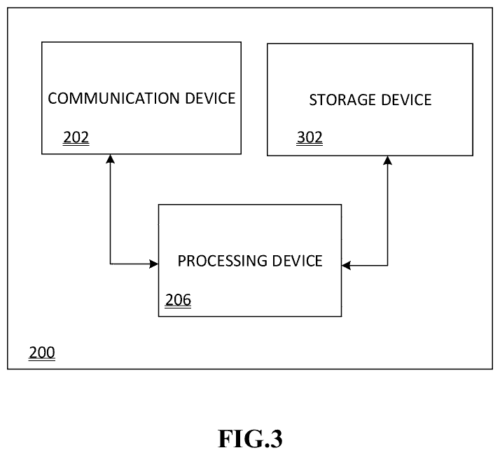

FIG. 3 is a block diagram of a system 300 for facilitating exploration of data to evaluate activities and behavioral patterns for making decisions, in accordance with further embodiments. Accordingly, the system 300 may include the communication device 202, the processing device 204, and a storage device 302. Further, the processing device 204 may be configured for executing at least one internal software process. Further, the storage device 302 may be configured for storing data based on the executing, wherein the data comprises the geographical data.

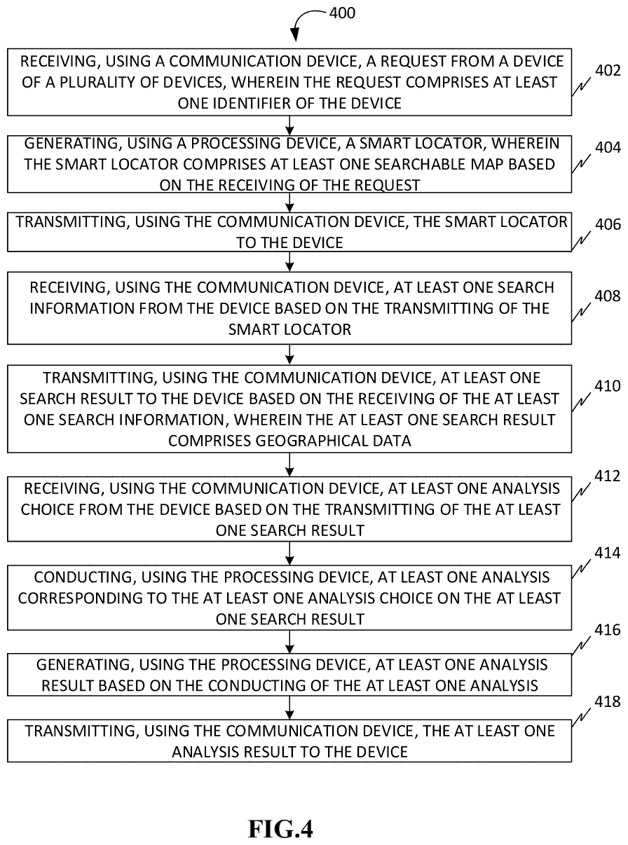

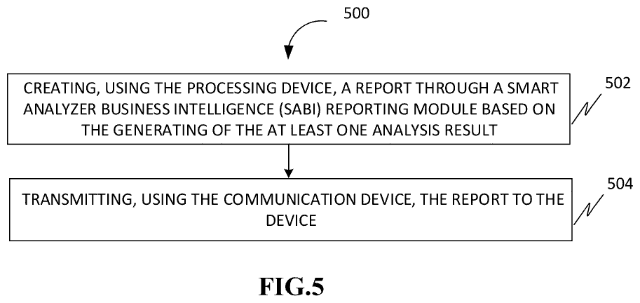

FIG. 4 is a flowchart of a method 400 for facilitating exploration of data to evaluate activities and behavioral patterns for making decisions, in accordance with some embodiments.

At 402, the method 400 may include receiving, using a communication device (such as the communication device 202), a request from a device of a plurality of devices. Further, the request may include at least one identifier of the device. Further, the plurality of devices may be associated with a plurality of users (such as the user 112). Further, the device may include a computing device such as, but not limited to, a smartphone, a laptop, a desktop, a PC device, a smartwatch, a tablet, and so on.

At 404, the method 400 may include generating, using a processing device (such as the processing device 204), a smart locator. Further, the smart locator may include at least one searchable map based on the receiving of the request.

Further, the at least one searchable map may include at least one clickable location icon. Further, each clickable location icon of the at least one clickable location icon may be linked to data. Further, the at least one search information may include at least one selection of the at least one clickable location icon. Further, the data may include the geographical data.

At 406, the method 400 may include transmitting, using the communication device, the smart locator to the device.

At 408, the method 400 may include receiving, using the communication device, at least one search information from the device based on the transmitting of the smart locator. Further, the at least one search information may include at least one location address on the at least one searchable map.

At 410, the method 400 may include transmitting, using the communication device, at least one search result to the device based on the receiving of the at least one search information. Further, the at least one search result may include geographical data.

At 412, the method 400 may include receiving, using the communication device, at least one analysis choice from the device based on the transmitting of the at least one search result.

At 414, the method 400 may include conducting, using the processing device, at least one analysis corresponding to the at least one analysis choice on the at least one search result.

At 416, the method 400 may include generating, using the processing device, at least one analysis result based on the conducting of the at least one analysis.

At 418, the method 400 may include transmitting, using the communication device, the at least one analysis result to the device.

In further, embodiments, the method 400 may include obtaining, using the processing device, the geographical data through a specialized data translator engine. Further, the specialized data translator engine may be configured for receiving, collecting, transforming, and loading the data from a plurality of sources to at least one database. Further, the plurality of sources may be non-homogeneous.

FIG. 5 is a flowchart of a method 500 for sending a report to the device, in accordance with some embodiments.

At 502, the method 500 may include creating, using the processing device, the report through a smart analyzer business intelligence (SABI) reporting module based on the generating of the at least one analysis result.

At 504, the method 500 may include transmitting, using the communication device, the report to the device.

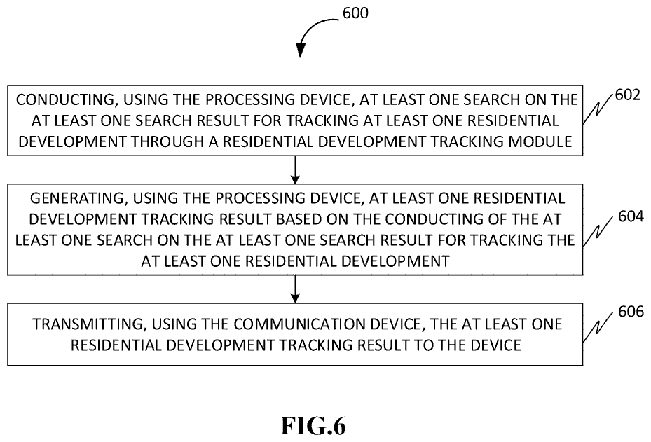

FIG. 6 is a flowchart of a method 600 for sending at least one residential development tracking result to the device, in accordance with some embodiments. Further, the at least one search information may be associated with a residential development tracking.

At 602, the method 600 may include conducting, using the processing device, at least one search on the at least one search result for tracking at least one residential development through a residential development tracking module.

At 604, the method 600 may include generating, using the processing device, the at least one residential development tracking result based on the conducting of the at least one search on the at least one search result for tracking the at least one residential development.

At 606, the method 600 may include transmitting, using the communication device, the at least one residential development tracking result to the device.

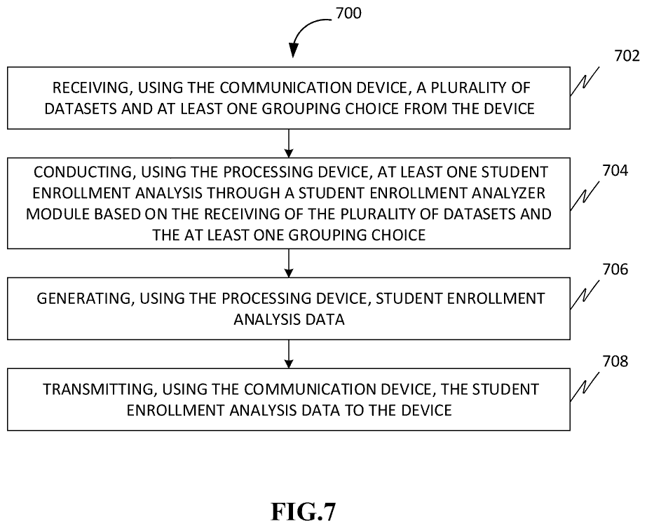

FIG. 7 is a flowchart of a method 700 for sending student enrollment analysis data to the device, in accordance with some embodiments.

At 702, the method 700 may include receiving, using the communication device, a plurality of datasets and at least one grouping choice from the device.

At 704, the method 700 may include conducting, using the processing device, at least one student enrollment analysis through a student enrollment analyzer module based on the receiving of the plurality of datasets and the at least one grouping choice.

At 706, the method 700 may include generating, using the processing device, the student enrollment analysis data.

At 708, the method 700 may include transmitting, using the communication device, the student enrollment analysis data to the device.

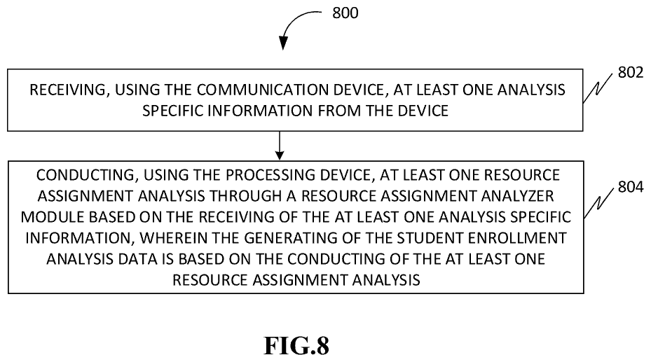

FIG. 8 is a flowchart of a method 800 for performing at least one resource assignment analysis, in accordance with some embodiments.

At 802, the method 800 may include receiving, using the communication device, at least one analysis specific information from the device.

At 804, the method 800 may include conducting, using the processing device, the at least one resource assignment analysis through a resource assignment analyzer module based on the receiving of the at least one analysis specific information. Further, the generating of the student enrollment analysis data may be based on the conducting of the at least one resource assignment analysis.

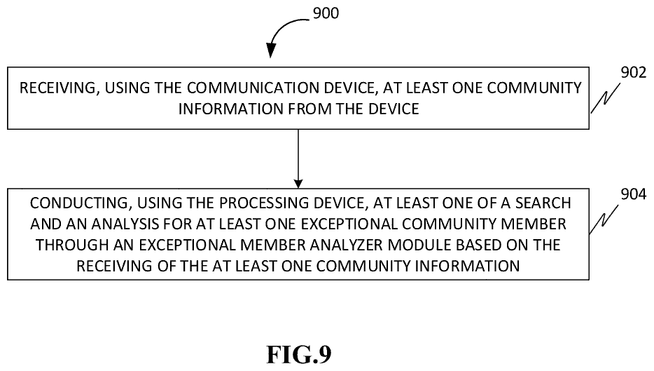

FIG. 9 is a flowchart of a method 900 for performing at least one of a search and an analysis for at least one exceptional community member, in accordance with some embodiments.

At 902, the method 900 may include receiving, using the communication device, at least one community information from the device.

At 904, the method 900 may include conducting, using the processing device, at least one of the search and the analysis for the at least one exceptional community member through an exceptional member analyzer module based on the receiving of the at least one community information. Further, the generating of the student enrollment analysis data may be based on the conducting of at least one of the search and the analysis for the at least one exceptional community member.

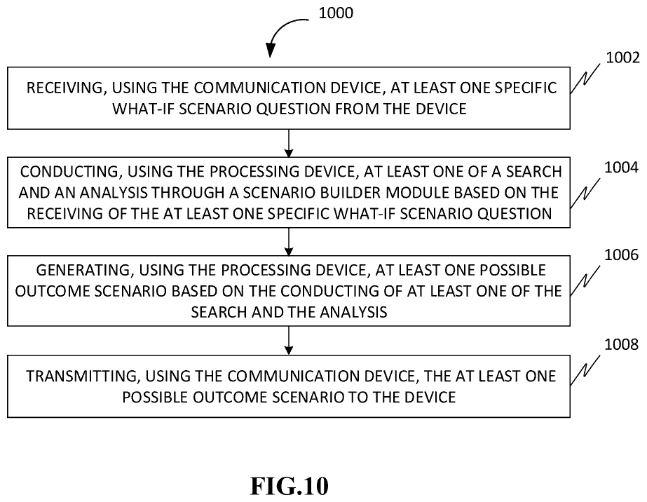

FIG. 10 is a flowchart of a method 1000 for at least one possible outcome scenario to the device, in accordance with some embodiments.

At 1002, the method 1000 may include receiving, using the communication device, at least one specific what-if scenario question from the device.

At 1004, the method 1000 may include conducting, using the processing device, at least one of a search and an analysis through a scenario builder module based on the receiving of the at least one specific what-if scenario question.

At 1006, the method 1000 may include generating, using the processing device, the at least one possible outcome scenario based on the conducting of at least one of the search and the analysis.

At 1008, the method 1000 may include transmitting, using the communication device, the at least one possible outcome scenario to the device.

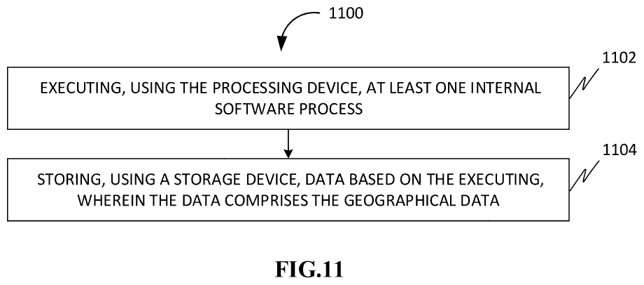

FIG. 11 is a flowchart of a method 1100 for saving data, in accordance with some embodiments.

At 1102, the method 1100 may include executing, using the processing device, at least one internal software process.

At 1104, the method 1100 may include storing, using a storage device, the data based on the executing. Further, the data may include the geographical data.

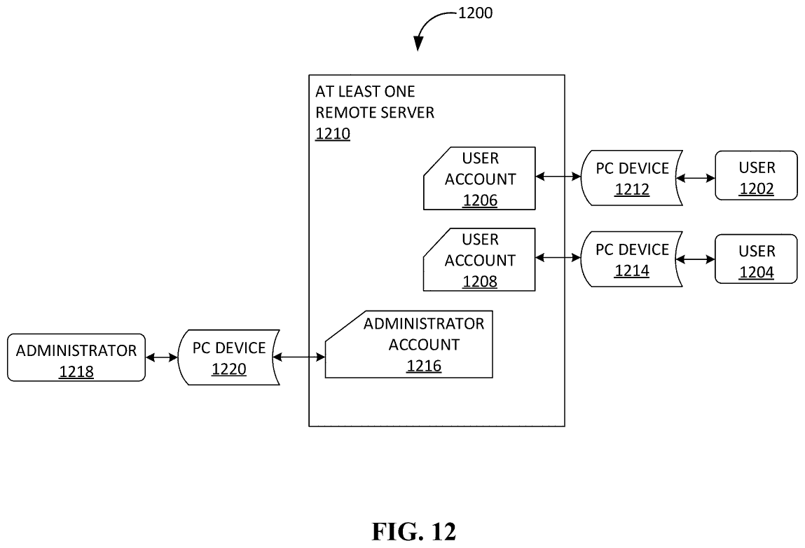

FIG. 12 is a block diagram of a system 1200 to manage a geographical and analytics suite of processes for a plurality of users 1202-1204, in accordance with some embodiments. Further, each of the plurality of users 1202-1204 may be associated with unique user accounts 1206-1208 from a plurality of user accounts that are managed by at least one remote server 1210. Further, each of the plurality of user accounts 1206-1208 may be associated with corresponding personal computing (PC) devices 1212-1214. The corresponding PC device (device) allows the user to interact with the at least one remote server 1210. Further, the user may interact with the at least one remote server 1210 using the PC device such as, a smartphone, a smartwatch, a laptop, a desktop, a server, a server computer, a server terminal, a cloud PC, or a tablet PC. The plurality of users 1202-1204 may include relevant parties such as, but are not limited to, individuals, entities, consumers, technicians, engineers, agents, real estate agents, brokers, realtors, managers, corporate executives, business owners, consultants, school employees, teachers, principals, controllers, investors, service providers, contractors, planners, urban planners, local government officials, community officials, municipality officials, community planning officials, companies, corporations, associations, government entities, and administrators, etc. Further, the at least one remote server 1210 may be used to manage the honesty and credibility rating system for the plurality of user accounts 1206-1208. The at least one remote server 1210 may be managed through an administrator account 1216 by an administrator 1218. The administrator 1218 may manage the at least one remote server 1210 via a PC device 1220. The administrator 1218 may include, but is not limited to, technician, engineer, system specialist, system administrator, software engineer, consultant, manager, owner, executive officer, chief operating officer, chief technology officer, chief executive officer, president, company, corporation, organization, government entities, schools, etc. Moreover, the at least one remote server 1210 may be used to execute a number of internal software processes and store data related to the disclosed system and methods. The software processes may include, but are not limited to, server software programs, web-based software applications or browsers embodied as, for example, but not limited to, websites, web applications, desktop applications, and mobile applications compatible with a corresponding user PC device. Additionally, the software processes may store data into internal databases and communicate with external databases, which may include, but are not limited to, map databases such as Google Maps®, ESRI ArcGIS One Line Services, and Open Street Maps, US census databases, crime information databases, safety databases, databases maintaining data about economic indicators, financial information databases, education databases, school databases, student databases, databases maintaining data for local and/or community resources, real estate databases such as MLS® (Multiple Listing Service), property boundary databases, land survey databases, restaurant databases, service provider databases, etc. The interaction with external databases over a communication network may include, but is not limited to, the Internet.

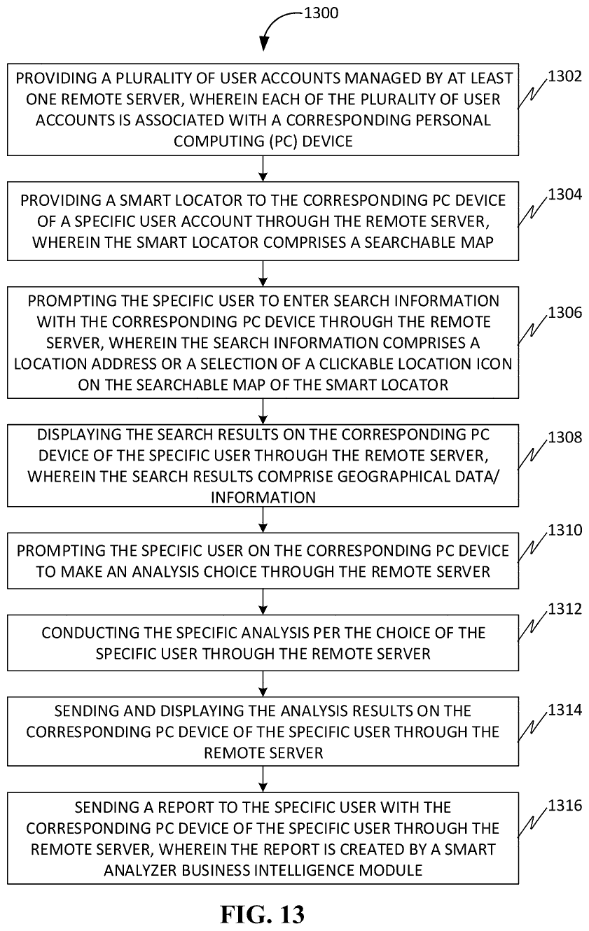

FIG. 13 is a flow chart of a method 1300 to manage a geographical and analytics suite of processes for a plurality of users, in accordance with some embodiments.

At 1302, the method 1300 may include providing a plurality of user accounts managed by at least one remote server, wherein each of the plurality of user accounts is associated with a corresponding personal computing (PC) device. This has explained in detail in conjunction with FIG. 12.

At 1304, the method 1300 may include providing a smart locator to the corresponding PC device of a specific user account through the remote server, wherein the smart locator comprises a searchable map. As one of the main interfaces with the specific user, the method 1300 may allow the specific user to start geographical data/information search through a smart locator module, which includes a searchable map that provides detailed data/information linked to a plurality of clickable location icons.

At 1306, the method 1300 may include prompting the specific user account to enter search information with the corresponding PC device through the remote server, wherein the search information may include a location address or a selection of a clickable location icon on the searchable map of the smart locator. Each of the plurality of clickable location icons can be, but is not limited to, a school, a service provider such as a restaurant, a hospital, a store, a plaza, a shopping mall, a car dealership, a car repair garage, a DMV (Department of Motor Vehicle) office, a hotel, a bank, a metro station, etc., a park, a government office, a company, a community service provider, etc.

At 1308, the method 1300 may include displaying the search results on the corresponding PC device of the specific user through the remote server, wherein the search results may include geographical data/information (Step D). Such geographical data/information is obtained and organized through a specialized data translator engine, the Open Bridge ETL, which receives, collects, transforms, and loads data/information from diverse and multiple sources into the internal databases of the present disclosure. Additionally, the Open Bridge ETL is a data pipeline with a set of tools, services, and processes tailored to coordinate the data collection work and provides the right level to the transformation phase. The Open Bridge ETL involves staging tables to hold temporary data used during the transformation process and applies various operations such as validating, cleaning, joining, and aggregating data. The main functions of the Open Bridge ETL include, but are not limited to, a.) geocoding of each service component such as community member residential address, service centers, points of interest, etc.; b.) validation of data values for demographic elements such as gender, race, and ethnicity; c.) verification of data values for community member data elements; d.) alignment of data across multiple sources such as Parcel layer, Street Network, and Address Points; e.) maintenance of historical data sources to support longitudinal studies.

At 1310, the method 1300 may include prompting the specific user on the corresponding device to make an analysis choice through the remote server.

Once an analysis choice is received, at 1312, the method 1300 may include conducting the specific analysis per the choice of the specific user through the remote server. The specific analysis may be conducted through a corresponding analyzer module that the method comprises.

Further, once the analysis is finished, at 1314, the method 1300 may include sending and displays the analysis results on the corresponding PC device of the specific user through the remote server.

Further, at 1316, the method 1300 may include sending a report to the specific user with the corresponding PC device of the specific user through the remote server, wherein the report is created by a smart analyzer business intelligence module. More specifically, the method creates and sends the report to the specific user through the smart analyzer business intelligence (SABI) reporting module. The SABI reporting module offers an effective and dynamic platform for information delivery, which enables the specific user to efficiently inquire integrated data in an effective manner to drive proactive decision-making and develop comprehensive action plans. The SABI reporting processes data timely and generates proper reporting and analysis to make more informed and evidence-based decisions. The SABI reporting combines traditional table-based reports with geographic analysis instantly, using the same dataset provided through the rest of the services and modules that the present disclosure offers. Additionally, the SABI reporting increases productivity, improves analysis and decision-making, and increases organizational communication and collaboration. Thus, the SABI reporting has a significant impact on an organization by fundamentally improving the way that users perform their jobs and how decisions are made. The most recognized and useful reports provided by SABI reporting include, but are not limited to, Community Popularity report, Community Member Mobility Analysis, Community Articulation report, Community Service Area Boundary Validation Analysis, Community Member Trend Analysis, Charter Community Report, Community Services Inventory, Crime Time Analysis, etc.

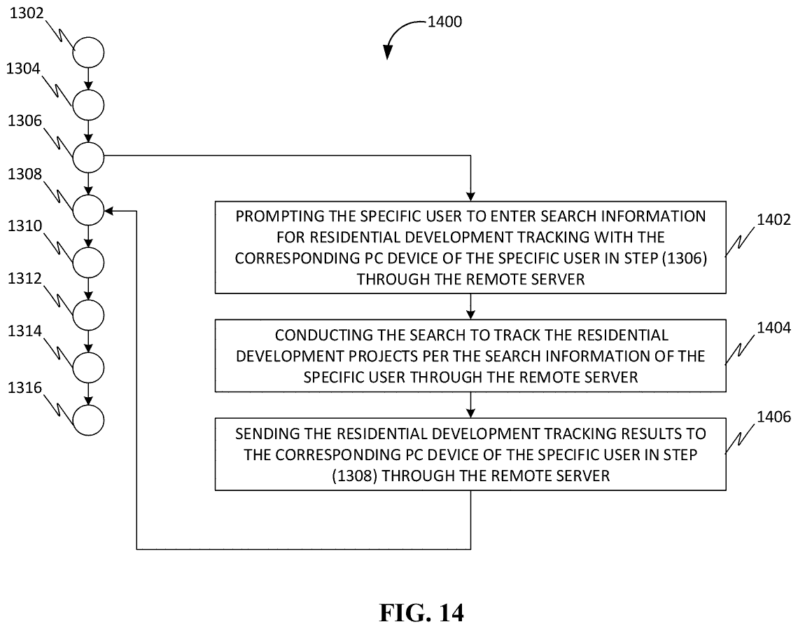

FIG. 14 is a flowchart of a method 1400 for managing residential development tracking for a desired geographical location for the specific user, in accordance with some embodiments.

At 1402, the method 1400 may include prompting the corresponding PC device of the specific user through the remote server to enter search information for residential development tracking with the corresponding PC device of the specific user in step 1306 (of FIG. 13) through the remote server.

At 1404, the method 1400 may include conducting the search to track the residential development projects per the search information of the specific user through the remote server.

At 1406, the method 1400 may include sending the residential development tracking results to the corresponding PC device of the specific user in step 1308 through the remote server.

The method 1400 is conducted through a residential development tracking module of the present disclosure, which supports the complete workflow to enter a residential project application including type and number of housing units and parcel identifications, and then calculates the number of student stations needed for planning and concurrency purposes, and the set of assigned schools based on the location of the project. The residential development tracking brings order and accountability to the urban growth process. This module automates the process for keeping track of future required student seats from different perspectives and allows users to combine current residential applications with other analytic tools such as community boundaries, street networks, and building permits. The main functional items offered by the residential development tracking module include, but are not limited to, a.) Definition of multiyear Student Generation Rates; b.) Definition of multiple Student Generation Rates per year; c.) Assignment of time-sensitive alerts by application status; d.) Creation of application of different types between Rezoning, Plan Amendment, Concurrency and Concurrency Exempt; e.) Calculation of Assigned schools on the fly based on the location of folio numbers included in the project; f.) Reprojection of Assigned schools on the fly based on new Community boundaries or adjusted folio numbers; g.) Selection of folio numbers directly from the geography of the project; h.) Tracking of the project completion percentage; i.) Adjustment of available seats considering project completion percentages; etc.

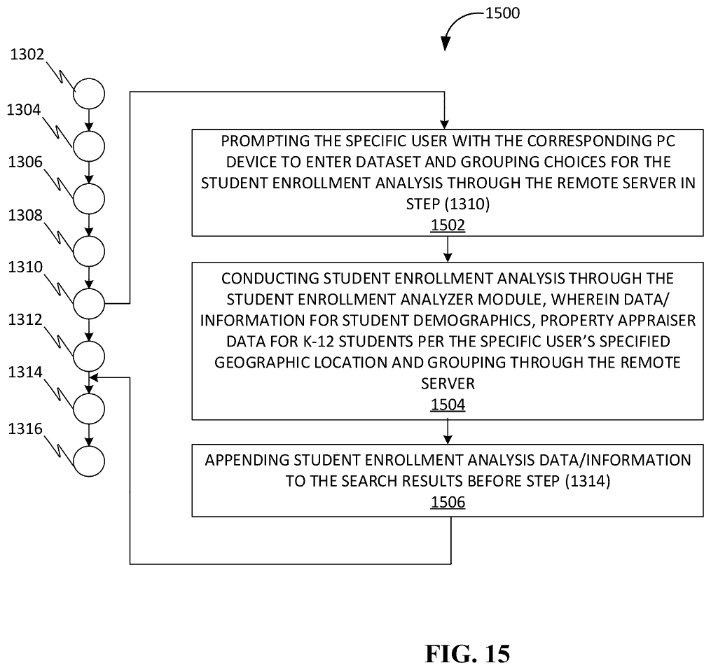

FIG. 15 is a flowchart of a method 1500 for managing student enrollment analysis for a specific user, in accordance with some embodiments. Further, the method 1500 may manage a student enrollment analysis.

At 1502, the method 1500 may include prompting the specific user with the corresponding PC device to enter dataset and grouping choices for the student enrollment analysis through the remote server in step 1310.

Once these inputs are received, at 1504, the method 1500 may include conducting student enrollment analysis through the Student Enrollment Analyzer module, wherein data/information for student demographics, property appraiser data for K-12 (Kindergarten to 12th grade) students per the specific user's specified geographic location and grouping through the remote server.

At 1506, the method 1500 may include appending student enrollment analysis data/information to the search results before the step 1314.

More specifically, the Student Enrollment Analyzer provides a powerful data analysis environment for students attending K-12 sites. The main function is to align data sources from multiple stakeholders and provides an easy and effective set of filters to focus on analysis and ad-hoc inquiries. In essence, the Student Enrollment Analyzer allows the user to analyze any multi-data source inquiry and visualize results immediately. Additionally, the Student Enrollment Analyzer is capable of solving multiple administrative questions that require combination and analysis of several datasets such as student demographics, residential development projects, and property appraiser data. Aggregation level to each inquiry is calculated based on the selection of data sources and grouping algorithms chosen by the user. Further, the main functions of the Student Enrollment Analyzer include, but are not limited to, selection of enrolled and/or assigned school; selection of one, several or all schools; selection of one, several or all grades; selection of grades by school level: Elementary, Middle, High; selection of current or historical data sources; filtering by ethnicity, gender, assigned school, enrolled school, placement code, zip code, or enrollment code, etc.; display of school boundaries, school grades, and walking areas (if available); display of local government layers such as parcels, building footprint, streets, administrative boundaries, and government buildings; option to export results to excel or flat files, etc.

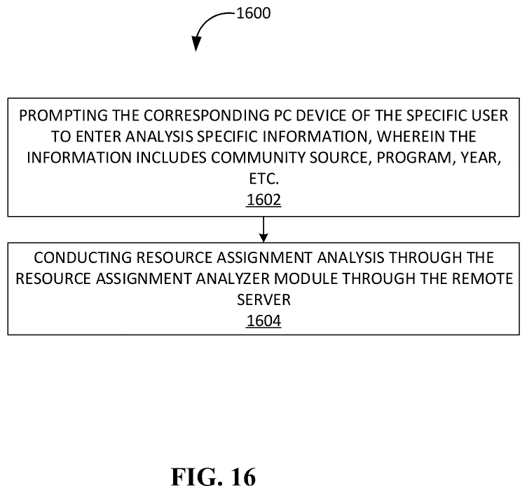

FIG. 16 is a flowchart of a method 1600 for managing resource assignment analysis for a specific user, in accordance with some embodiments.

At 1602, the method 1600 may include prompting the corresponding PC device of the specific user to enter analysis specific information, wherein the information includes community source, program, year, etc.

Once the analysis specific information is received, at 1604, the method 1600 may include conducting the corresponding PC device of the specific user to enter analysis specific information, wherein the information includes community source, program, year, etc.

More specifically, the Resource Assignment Analyzer offers a geographical approach to the community resource assignment process, which promotes equality in community resource repartition, ensuring that all members, and not only the most privileged, receive the right level of opportunity to get an offer to the community resources. The Resource Assignment allows community leaders in charge of community resource applications to understand application trends, clustering, and distribution of applicants, program offers, and member accepts generated by the selection process. The main functions of the Resource Assignment Analyzer include, but are not limited to, analysis by application status; search by applied community resource or program; option to select from different year and application rounds; cluster analysis; combination with all other functions from the Student Enrollment Analyzer, etc.

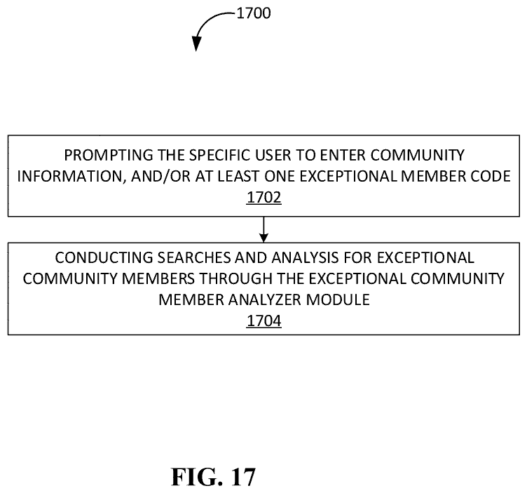

FIG. 17 is a flowchart of a method 1700 the method for managing exceptional community member analysis for a specific user, in accordance with some embodiments.

At 1702, the method 1700 may include prompting the specific user to enter community information, and/or at least one exceptional member code.

Once the analysis specific information is received, at 1704, the method 1700 may include conducting searches and analysis for exceptional member students through the Exceptional Member Analyzer module.

More specifically, the Exceptional Member Analyzer supports community resource mapping to serve community members identified as disabled or gifted. The Exceptional Member Analyzer helps community leaders to understand the geographic distribution of their Exceptional Member resources and community members to assign them in the most effective way possible and member performance. The main functions of the Exceptional Member Analyzer include, but are not limited to, analysis by one or multiple Exceptional Member codes; filtering by Exceptional Member student demographic variables; combination with Community Resource Assignment Analyzer data sources; etc.

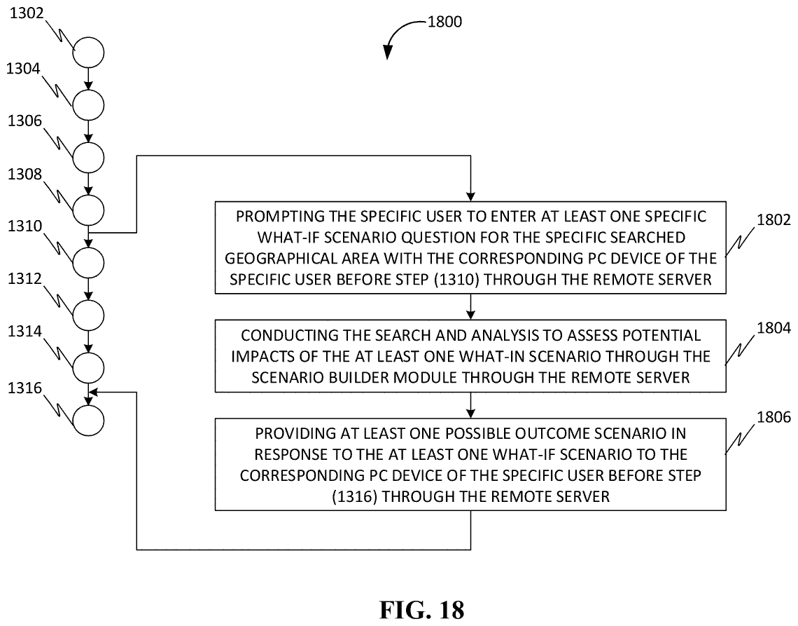

FIG. 18 is a flowchart of a method 1800 for managing what-if scenario analysis for a specific user, in accordance with some embodiments.

At 1802, the method 1800 may include prompting the specific user to enter at least one specific what-if scenario question for the specific searched geographical area with the corresponding PC device of the specific user before Step 1310 through the remote server.

Once the at least one specific what-in scenario information/questions is received, at 1804, the method 1800 may include conducting the search and analysis to assess potential impacts of the at least one what-in scenario through a Scenario Builder module through the remote server.

At 1806, the method 1800 may include providing at least one possible outcome scenario in response to the at least one what-if scenario to the corresponding PC device of the specific user before the step 1316 through the remote server.

More specifically, the Scenario Builder is the essential tool for community planning and allows urban planners to assess potential impacted areas at several levels, draw area of analysis on-the-fly with one, two or more polygons, and generate aggregates by several criteria. The Scenario builder brings the power of geography to the decision-making process combining user location, current, past, and new community resource boundaries, parcel layer, and any other dataset available from the community resources. The final result provided by the Scenario Builder is transparency and agility to the conversation at multiple levels of the organization, from the planning area to the community leaders, and the public in general. The main functions of the Scenario Builder include, but are not limited to, creation of scenarios per user; creation of multi-polygon scenarios; duplication of scenarios; sharing of scenarios; edition of scenarios; indication of active/inactive scenarios; combination with all other

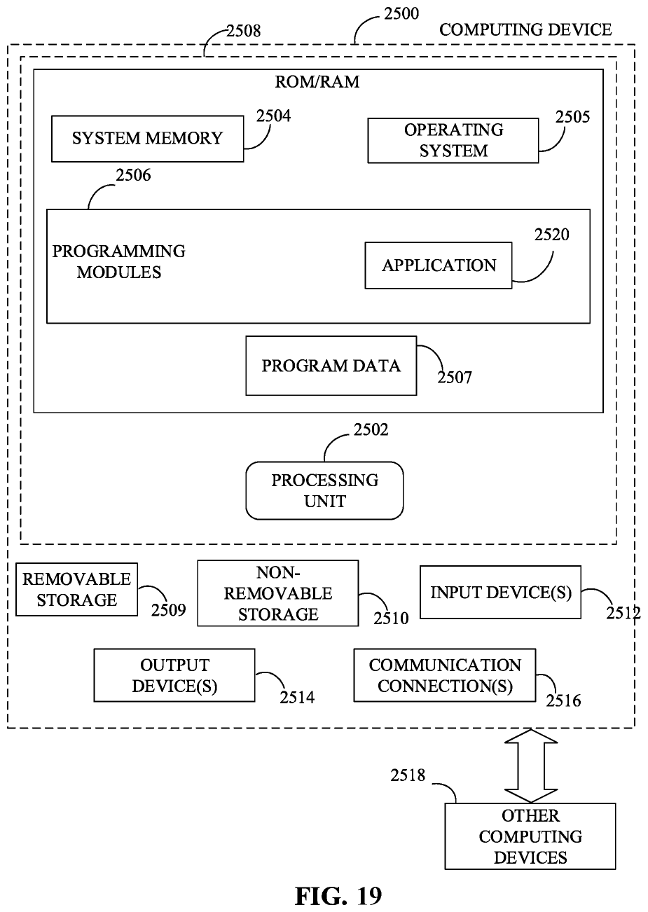

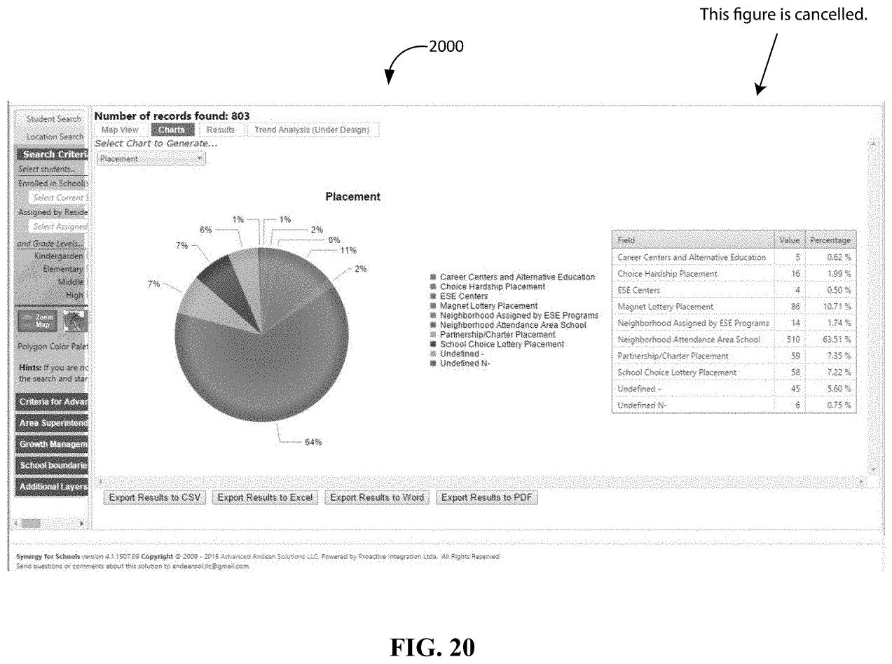

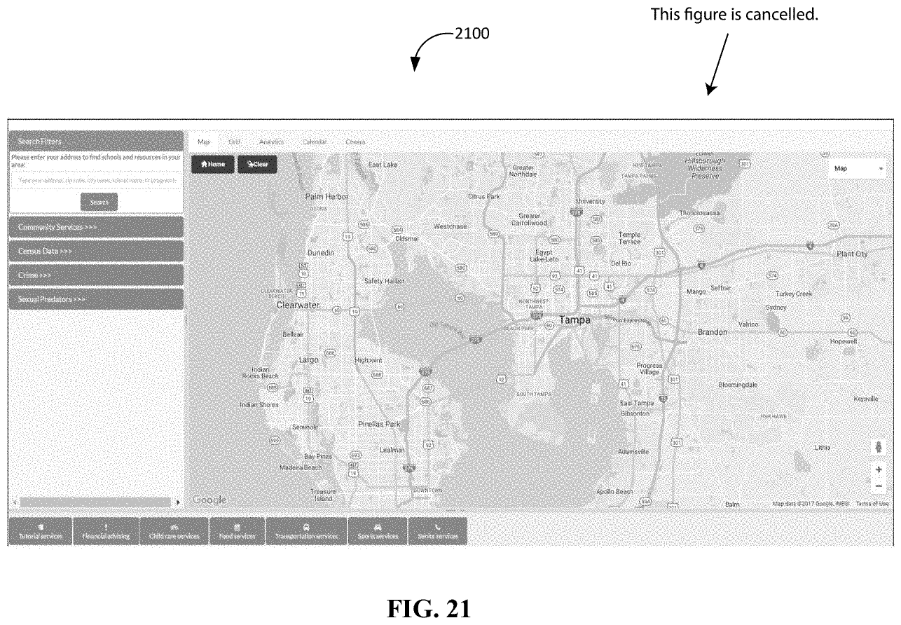

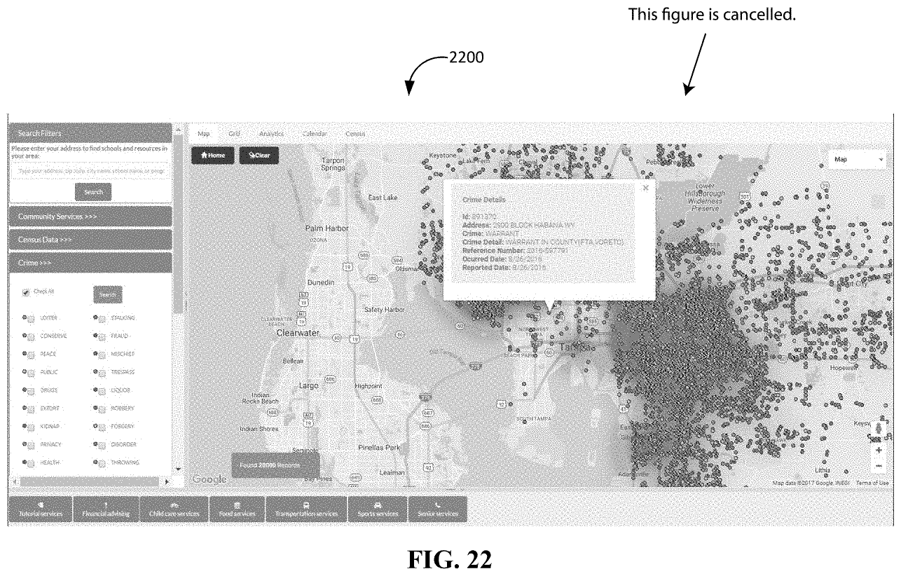

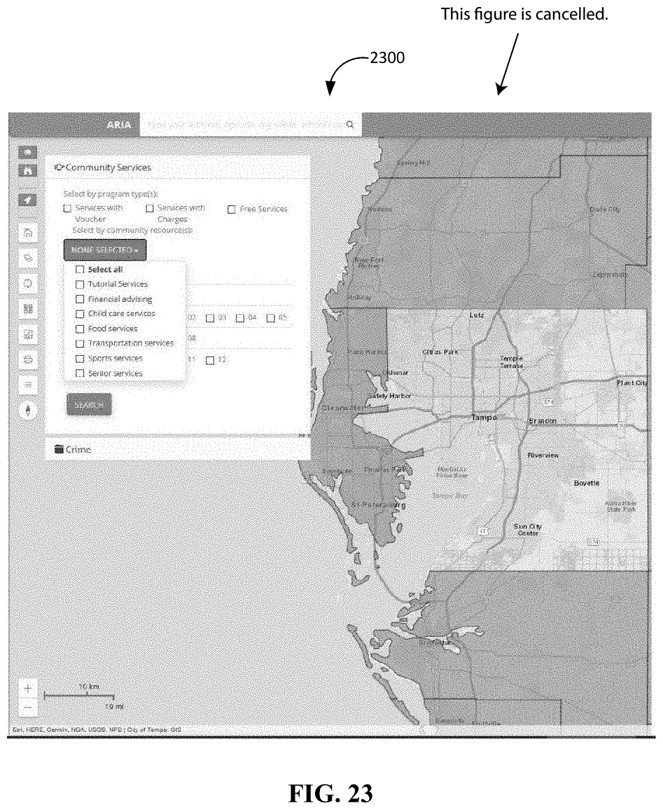

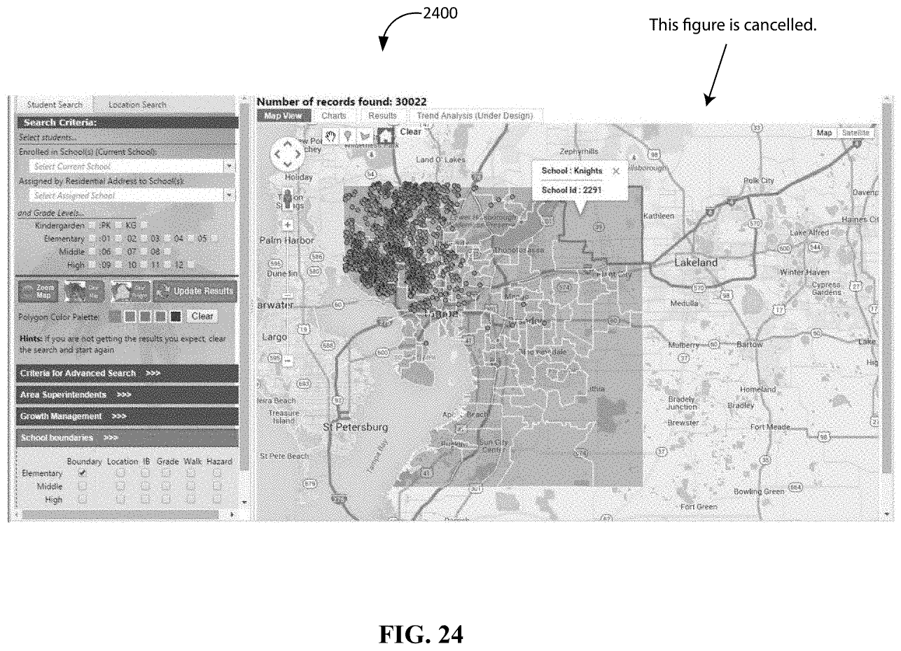

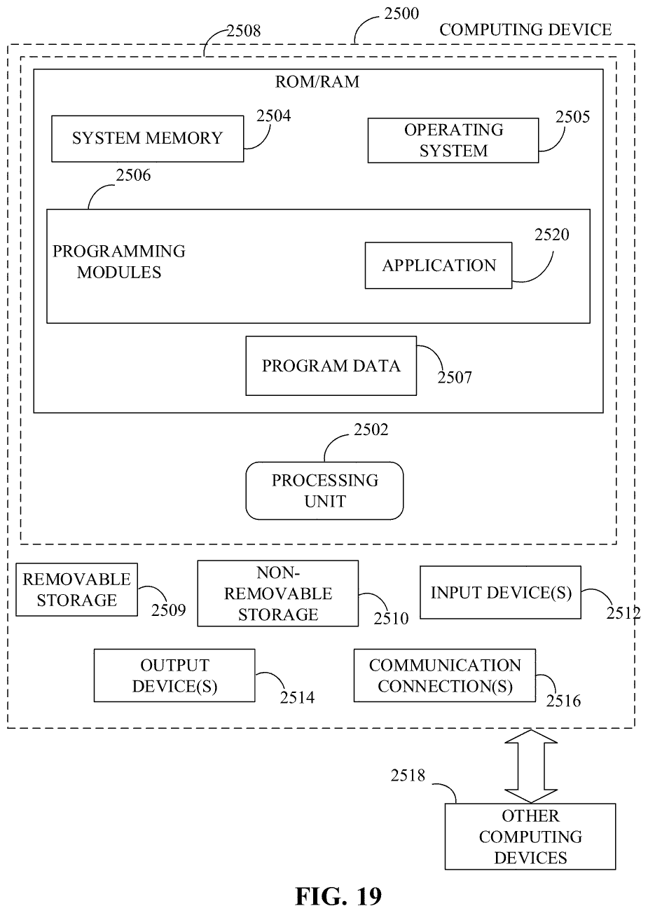

With reference to FIG. 19, a system consistent with an embodiment of the disclosure may include a computing device or cloud service, such as computing device 2500. In a basic configuration, computing device 2500 may include at least one processing unit 2502 and a system memory 2504. Depending on the configuration and type of computing device, system memory 2504 may comprise, but is not limited to, volatile (e.g. random-access memory (RAM)), non-volatile (e.g. read-only memory (ROM)), flash memory, or any combination. System memory 2504 may include operating system 2505, one or more programming modules 2506, and may include a program data 2507. Operating system 2505, for example, may be suitable for controlling computing device 2500's operation. In one embodiment, programming modules 2506 may include the image-processing module, machine learning module. Furthermore, embodiments of the disclosure may be practiced in conjunction with a graphics library, other operating systems, or any other application program and is not limited to any particular application or system. This basic configuration is illustrated in FIG. 25 by those components within a dashed line 2508.

Computing device 2500 may have additional features or functionality. For example, the computing device 2500 may also include additional data storage devices (removable and/or non-removable) such as, for example, magnetic disks, optical disks, or tape. Such additional storage is illustrated in FIG. 25 by a removable storage 2509 and a non-removable storage 2510. Computer storage media may include volatile and non-volatile, removable and non-removable media implemented in any method or technology for storage of information, such as computer-readable instructions, data structures, program modules, or other data. System memory 2504, removable storage 2509, and non-removable storage 2510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2500. Any such computer storage media may be part of device 2500. Computing device 2500 may also have input device(s) 2512 such as a keyboard, a mouse, a pen, a sound input device, a touch input device, a location sensor, a camera, a biometric sensor, etc. Output device(s) 2514 such as a display, speakers, a printer, etc. may also be included. The aforementioned devices are examples and others may be used.

Computing device 2500 may also contain a communication connection 2516 that may allow device 2500 to communicate with other computing devices 2518, such as over a network in a distributed computing environment, for example, an intranet or the Internet. Communication connection 2516 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2504, including operating system 2505. While executing on processing unit 2502, programming modules 2506 (e.g., application 2520 such as a media player) may perform processes including, for example, one or more stages of methods, algorithms, systems, applications, servers, databases as described above. The aforementioned process is an example, and processing unit 2502 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating exploration of data to evaluate activities and behavioral patterns for making decisions, the method comprising:
receiving, using a communication device, a request from a device of a plurality of devices, wherein the request comprises at least one identifier of the device;
generating, using a processing device, a smart locator, wherein the smart locator comprises at least one searchable map based on the receiving of the request;
transmitting, using the communication device, the smart locator to the device;
receiving, using the communication device, at least one search information from the device based on the transmitting of the smart locator, wherein the at least one search information comprises at least one location address on the at least one searchable map;
transmitting, using the communication device, at least one search result to the device based on the receiving of the at least one search information, wherein the at least one search result comprises geographical data;
receiving, using the communication device, at least one analysis choice from the device based on the transmitting of the at least one search result;
conducting, using the processing device, at least one analysis corresponding to the at least one analysis choice on the at least one search result;
generating, using the processing device, at least one analysis result based on the conducting of the at least one analysis; and
transmitting, using the communication device, the at least one analysis result to the device.

2. The method of claim 1, wherein the at least one searchable map comprises at least one clickable location icon, wherein each clickable location icon of the at least one clickable location icon is linked to data, wherein the at least one search information comprises at least one selection of the at least one clickable location icon, wherein the data comprises the geographical data.

3. The method of claim 2 further comprising obtaining, using the processing device, the geographical data through a specialized data translator engine, wherein the specialized data translator engine configured for receiving, collecting, transforming and loading the data from a plurality of sources to at least one database, wherein the plurality of sources is non-homogeneous.

4. The method of claim 1 further comprising:
creating, using the processing device, a report through a smart analyzer business intelligence (SABI) reporting module based on the generating of the at least one analysis result; and
transmitting, using the communication device, the report to the device.

5. The method of claim 1, wherein the at least one search information is associated with a residential development tracking, wherein the method further comprises:
conducting, using the processing device, at least one search on the at least one search result for tracking at least one residential development through a residential development tracking module;
generating, using the processing device, at least one residential development tracking result based on the conducting of the at least one search on the at least one search result for tracking the at least one residential development; and
transmitting, using the communication device, the at least one residential development tracking result to the device.

6. The method of claim 1 further comprising:
receiving, using the communication device, a plurality of datasets and at least one grouping choice from the device;
conducting, using the processing device, at least one student enrollment analysis through a student enrollment analyzer module based on the receiving of the plurality of datasets and the at least one grouping choice;
generating, using the processing device, student enrollment analysis data; and
transmitting, using the communication device, the student enrollment analysis data to the device.

7. The method of claim 6 further comprising:
receiving, using the communication device, at least one analysis specific information from the device; and
conducting, using the processing device, at least one resource assignment analysis through a resource assignment analyzer module based on the receiving of the at least one analysis specific information, wherein the generating of the student enrollment analysis data is based on the conducting of the at least one resource assignment analysis.

8. The method of claim 6 further comprising:
receiving, using the communication device, at least one community information from the device; and
conducting, using the processing device, at least one of a search and an analysis for at least one exceptional community member through an exceptional member analyzer module based on the receiving of the at least one community information, wherein the generating of the student enrollment analysis data is based on the conducting of at least one of the search and the analysis for the at least one exceptional community member.

9. The method of claim 1 further comprising:
receiving, using the communication device, at least one specific what-if scenario question from the device;
conducting, using the processing device, at least one of a search and an analysis through a scenario builder module based on the receiving of the at least one specific what-if scenario question;
generating, using the processing device, at least one possible outcome scenario based on the conducting of at least one of the search and the analysis; and
transmitting, using the communication device, the at least one possible outcome scenario to the device.

10. The method of claim 1 further comprising:
executing, using the processing device, at least one internal software process; and
storing, using a storage device, data based on the executing, wherein the data comprises the geographical data.

11. A system for facilitating exploration of data to evaluate activities and behavioral patterns for making decisions, the system comprising:
a communication device configured for:
receiving a request from a device of a plurality of devices, wherein the request comprises at least one identifier of the device;
transmitting a smart locator to the device;
receiving at least one search information from the device based on the transmitting of the smart locator, wherein the at least one search information comprises at least one location address on at least one searchable map;
transmitting at least one search result to the device based on the receiving of the at least one search information, wherein the at least one search result comprises geographical data;
receiving at least one analysis choice from the device based on the transmitting of the at least one search result; and
transmitting at least one analysis result to the device; and
a processing device configured for:
generating the smart locator, wherein the smart locator comprises the at least one searchable map based on the receiving of the request;
conducting at least one analysis corresponding to the at least one analysis choice on the at least one search result; and
generating the at least one analysis result based on the conducting of the at least one analysis.

12. The system of claim 11, wherein the at least one searchable map comprises at least one clickable location icon, wherein each clickable location icon of the at least one clickable location icon is linked to data, wherein the at least one search information comprises at least one selection of the at least one clickable location icon, wherein the data comprises the geographical data.

13. The system of claim 12, wherein the processing device is further configured for obtaining the geographical data through a specialized data translator engine, wherein the specialized data translator engine configured for receiving, collecting, transforming and loading the data from a plurality of sources to at least one database, wherein the plurality of sources is non-homogeneous.

14. The system of claim 11, wherein the processing device is further configured for creating a report through a smart analyzer business intelligence (SABI) reporting module based on the generating of the at least one analysis result, wherein the communication device is further configured for transmitting the report to the device.

15. The system of claim 11, wherein the at least one search information is associated with a residential development tracking, wherein the processing device is further configured for:
conducting at least one search on the at least one search result for tracking at least one residential development through a residential development tracking module; and
generating at least one residential development tracking result based on the conducting of the at least one search on the at least one search result for tracking the at least one residential development, wherein the communication device is further configured for transmitting the at least one residential development tracking result to the device.

16. The system of claim 11, wherein the communication device is further configured for:
receiving a plurality of datasets and at least one grouping choice from the device; and
transmitting student enrollment analysis data to the device, wherein the processing device is further configured for:
conducting at least one student enrollment analysis through a student enrollment analyzer module based on the receiving of the plurality of datasets and the at least one grouping choice; and
generating the student enrollment analysis data.

17. The system of claim 16, wherein the communication device is further configured for receiving at least one analysis specific information from the device, wherein the processing device is further configured for conducting at least one resource assignment analysis through a resource assignment analyzer module based on the receiving of the at least one analysis specific information, wherein the generating of the student enrollment analysis data is based on the conducting of the at least one resource assignment analysis.

18. The system of claim 16, wherein the communication device is further configured for receiving at least one community information from the device, wherein the processing device is further configured for conducting at least one of a search and an analysis for at least one exceptional community member through an exceptional member analyzer module based on the receiving of the at least one community information, wherein the generating of the student enrollment analysis data is based on the conducting of at least one of the search and the analysis for the at least one exceptional community member.

19. The system of claim 11, wherein the communication device is further configured for:
receiving at least one specific what-if scenario question from the device; and
transmitting at least one possible outcome scenario to the device, wherein the processing device is further configured for:
conducting at least one of a search and an analysis through a scenario builder module based on the receiving of the at least one specific what-if scenario question; and
generating the at least one possible outcome scenario based on the conducting of at least one of the search and the analysis.

20. The system of claim 11, wherein the processing device is further configured for executing at least one internal software process, wherein the system further comprises a storage device configured for storing data based on the executing, wherein the data comprises the geographical data.
